(19) United States
(12) Patent Application Publication
(10) Pub. No.: US 2010/0134502 A1
(43) Pub. Date: Jun. 3, 2010

(54) Display method and viewing device making it possible to protect the screen against freezing of the image

(75) Inventors: Philippe Pradere, Bordeaux (FR); Philippe Ponsard, Saint Medard en Jalles (FR); Jean-Rene Verbeque, Saint Aubin De Medoc (FR); Gerard Isidore Andre Voisin, Saint Medard en Jalles (FR)

Correspondence Address: LARIVIERE, GRUBMAN & PAYNE, LLP, 19 UPPER RAGSDALE DRIVE, SUITE 200, MONTEREY, CA, 93940, US

(73) Assignee: Thales, Neuilly Sur Seine (FR)

(21) Appl. No.: 12/623,141

(22) Filed: Nov. 20, 2009

(30) Foreign Application Priority Data
Nov. 21, 2008 (FR) 08 06556

(51) Int. Cl. G06T 1/00

(52) U.S. Cl. 345/522

(57) ABSTRACT

The invention relates to a display method for an image-generation means making it possible to protect a screen of a viewing device against freezing of the image, characterized in that the image-generation means continually and alternately displays during the operation of the said viewing device a first sub-image and a second sub-image the first sub-image comprising a warning message and the second sub-image being the negative image of the first sub-image, the frequency of the display being sufficiently high to hide the warning message and when the viewing device sustains a failure causing the freezing of the image, the image-generation means permanently displays the warning message according to the last sub-image displayed on the screen.

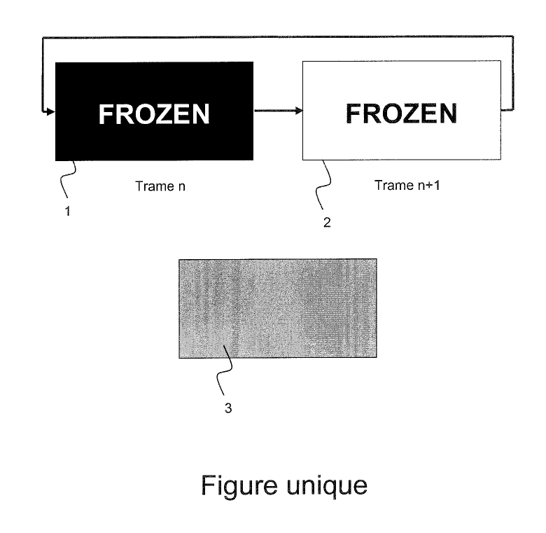

The invention applies particularly to the aviation field and more generally to any field in which a frozen image failure of a screen is critical.

### PRIORITY CLAIM

This application claims priority to French Patent Application Number 08 06556, entitled Procede D'Affichage Et Dispositif De Visualisation Permettant De Securiser L'Ecran Contre Le Gel D'Image, filed on Nov. 21, 2008.

### FIELD OF THE INVENTION

The field of the invention is that of the image-generation methods making it possible to protect a screen of a viewing device against freezing of the image. The invention relates particularly to viewing devices for the aviation field.

### BACKGROUND OF THE INVENTION

The use of flat-screen display devices for viewing parameters for piloting an aircraft has revealed a new risk which is the display of an image that is called frozen, that is to say the content of which is no longer representative of the actual state of the bearer.

In the aviation field, this situation is problematical in the cases in which it persists. Specifically, for displaying data of navigation systems, such a malfunction almost inevitably leads to a major accident.

This phenomenon appears following a malfunction of the image-generation system. The same image is displayed permanently on the screen of the viewing device in question. The sources of the problem may be multiple: some are specific to the image-generation means, others originate from the finite state machine which sends the pixels to the screen, others from the sequencer which orders the tasks or else others are specific to the screen and its control circuits.

When the malfunction originates from the hardware means of the image-generation system upstream of the screen, the latter is usually easy to detect by placing control points at well-chosen locations of the image-generation system.

However, the same does not apply to the malfunctions that are intrinsic to the screen. Specifically, at the latter level, the malfunction is no longer electrical but optical. It is therefore much more difficult to detect it.

The means that exist for detecting a freezing of the image originating from a malfunction of the screen can be achieved:
in a first solution, by designing an electronic system for monitoring the screen drivers, the system being incorporated into the said screen,
in a second solution, by designing an electronic system for monitoring the drivers and the panel by measuring the current consumed,
in a third solution, by designing an electronic system for monitoring the drivers and the panel, comprising electro-optical sensors.

The aforementioned solutions are effective, however, they lead to specific hardware developments and are not applicable to standard screens available on the market.

### SUMMARY OF THE INVENTION

The object of the invention is to propose a solution making it possible to detect a freezing of the image irrespective of the source of the malfunction and on any type of panel, notably the standard panels available on the market. It also has the objective of avoiding the design of dedicated electronic systems for solving frozen image problems requiring the modification or arrangement of the viewing hardware.

More precisely, the invention relates to a display method for an image-generation means making it possible to protect a screen of a viewing device against freezing of the image, characterized in that the image-generation means continually and alternately displays during the operation of the said viewing device a first sub-image and a second sub-image, the first sub-image comprising a warning message and the second sub-image being the negative image of the first sub-image, the frequency of the display being sufficiently high to hide the warning message, and when the viewing device sustains a failure causing the freezing of the image, the image-generation means permanently displays the warning message according to the last sub-image displayed on the screen.

Preferably, the said sub-images are displayed alternately at a sufficiently high frequency that the pixel zone of the sub-images is perceived by an operator as a uniform zone. The display frequency of the sub-images corresponds to the display frequency of the memory frames.

Preferably, the pixel zone of the sub-images is positioned in a pixel zone of greater size the pixel level of which is substantially invariable during the operation of the device and the average level of the pixels of the zone of the sub-images during the time of display of at least one pair of successive sub-images is substantially equal to the level of the pixels surrounding the zone of the said sub-images.

In one embodiment of the method, the sub-images are formed by a warning message comprising several characters on a substantially uniform background, and the profile of variation of the level of the pixels between a pixel inside a character and a pixel representing the background of a sub-image is progressive. The border of the characters of the message is preferably progressive and not sudden with the background of the image. Therefore, the pixel zone displaying the warning messages glitters less and virtually does not attract the gaze of the operator.

The invention relates particularly to the viewing device for an aircraft or to any hardware means relating to the image-generation system.

The invention achieves the aforementioned objectives:

It protects the flat screens without adding hardware or specific electronic systems in the display control stages. It is therefore possible to use standard screens available on the market with no modifications.

It applies equally to any type of viewing device for an aircraft: head-down devices, head-up devices or devices integrated into the helmet.

### BRIEF DESCRIPTION OF THE DRAWINGS

The invention will be better understood and other advantages will appear on reading the following description given in a non-limiting manner and with the help of the appended figures amongst which:

The single FIGURE represents three sub-images. The two sub-images situated at the top of the page of the figures are displayed alternately on the screen during the operation of the viewing device. The third sub-image represents the sub-image perceived by the operator during the display.

### DETAILED DESCRIPTION OF PREFERRED EMBODIMENT

An essential feature of the method according to the invention is to display a warning message during the correct operation of the viewing device. This warning message is displayed alternately in the form of two sub-images or icons the characteristics of which are complementary. By using the physiological properties of vision, notably of retinol persistence, the display alternating the two sub-images at a sufficiently high frequency makes it possible, during the correct operation of the viewing device, to hide the content or the message of the two sub-images or icons from the operator.

However, if a frozen-image problem arises and persists long enough, the warning message becomes visible to the operator because a single image remains displayed permanently and the process of hiding by retinal persistence does not take place.

The first sub-image represents the positive image of the warning message and the second sub-image represents the negative image of the warning message. The said sub-images are defined so that the total of the pixel levels of the zone of the sub-images during the time of display of a pair of successive sub-images is substantially equal for each pixel.

The displayed message may be graphical or textual. It may be an icon for example. This message should preferably be positioned in a zone of the screen that is not used very much for the normal usage of the viewing device.

As a non-limiting example, the single FIGURE represents a message in text form. The method according to the invention displays continually and alternately the warning message in the form of two sub-images 1 and 2 on the screen. For the hiding effect to be effective, the two sub-images are positioned at the same display coordinates. A first image frame n displays the sub-image 1 and the next image frame n+1 displays the sub-image 2. By displaying continually and alternately these two sub-images at a sufficiently high frequency, the sub-image perceived by the operator corresponds to a uniform background as illustrated by the sub-image 3. The pixel level of this sub-image seen by the operator corresponds to the average of the pixels during the time of display of two frames. Consequently, during the operation of the viewing device, the pixel zone corresponding to the sub-images 1 and 2 is a uniform zone that does not attract the attention of the operator.

The frequency of display of the sub-images is the frequency of display of the frames originating from the image-generation system.

The display method computes two complementary images so that the average level of each pixel is identical for the pair of sub-images 1 and 2. For example, the sub-image 1 comprises a black background and a text message in white characters and the sub-image 2 comprises a white background and a text message in black characters. The average level for the two sub-images therefore codes for a grey level.

Preferably the edge of the characters comprising the message should be produced in a progressive manner, that is to say that the profile of variation of pixel level between the pixels of a character and the coding pixels for the background of the sub-image should not change suddenly. In this manner, the sparkling around the message will be less distracting for the operator. The construction of the sub-images is optimized to prevent the appearance of a sparkle.

The pixel levels of the sub-images also change as a function of the change in the pixel zone surrounding the sub-images. Preferably, the sub-images are positioned close to a substantially invariable uniform background. The average pixel level for a pair of successive sub-images is preferably equal to the level of the pixels positioned nearby. If the level of the surrounding pixels changes, the level of the pixels of the sub-images also changes so that the average level of the pixels of a pair of sub-images is identical.

The sub-images are generated by the graphic computing means of the image-generation system of the viewing device. These computing means may be a graphic processor dedicated to image-generation, or a non-specific computing processor, a microcontroller, etc. Those skilled in the art are aware of the various computing means that can be used for the method and consequently the scope of the invention is not limited to one particular embodiment.

The invention applies particularly to the viewing devices that must be protected against the freezing of the image. It relates particularly to the critical fields in which the safety of people must be ensured and does not allow an image to display false data. This relates to viewing devices for a vehicle and more generally viewing devices for controlling critical parameters, such as, for example, a control station.

1. Display method for an image-generation means making it possible to protect a screen of a viewing device against freezing of the image, wherein the image-generation means continually and alternately displays during the operation of the said viewing device a first sub-image and a second sub-image, the first sub-image comprising a warning message and the second sub-image being the negative image of the first sub-image, the frequency of the display being sufficiently high to hide the warning message, and when the viewing device sustains a failure causing the freezing of the image, the image-generation means permanently displays the warning message according to the last sub-image displayed on the screen.

2. Method according to claim 1, wherein the pixel zone of the sub-images is positioned in a pixel zone of greater size the pixel level of which is substantially invariable during the operation of the device.

3. Method according to claim 2, wherein the average level of the pixels of the sub-image zone during the time of display of at least one pair of successive sub-images is substantially equal to the level of the pixels surrounding the zone of the said sub-images.

4. Method according to claim 1 displaying sub-images consisting of a warning message comprising several characters on a substantially uniform background, wherein the profile of variation of pixel level between a pixel inside a character and a pixel representing the background of a sub-image is progressive.

5. Viewing device for an aircraft, comprising image-generation means that can perform the method according to claim 1.

6. Image-generation system, comprising means that can perform the method according to claim 1.
